(19) United States
(12) Patent Application Publication
(10) Pub. No.: US 2012/0236114 A1
(43) Pub. Date: Sep. 20, 2012

(54) DEPTH INFORMATION GENERATOR FOR GENERATING DEPTH INFORMATION OUTPUT BY ONLY PROCESSING PART OF RECEIVED IMAGES HAVING DIFFERENT VIEWS, AND RELATED DEPTH INFORMATION GENERATING METHOD AND DEPTH ADJUSTING APPARATUS THEREOF

(76) Inventors: Te-Hao Chang, Taipei City (TW); Hung-Chi Fang, Yilan County (TW)

(21) Appl. No.: 13/237,949

(22) Filed: Sep. 21, 2011

Related U.S. Application Data
(60) Provisional application No. 61/454,068, filed on Mar. 18, 2011.

(51) Int. Cl. H04N 13/00

(52) U.S. Cl. 348/43; 348/E13.002

(57) ABSTRACT

A depth information generator includes a receiving circuit and a depth information generating block having a first depth information generating circuit included therein. The receiving circuit is arranged for receiving a multi-view video stream which transmits a plurality of images respectively corresponding to different views. The first depth information generating circuit is coupled to the receiving circuit, and arranged for generating a first depth information output by only processing part of the received images. In addition, a depth information generating method includes following steps: receiving a multi-view video stream which transmits a plurality of images respectively corresponding to different views; and generating a first depth information output by only processing part of the received images.

### CROSS REFERENCE TO RELATED APPLICATIONS

This application claims the benefit of U.S. provisional application No. 61/454,068, filed on Mar. 18, 2011 and incorporated herein by reference.

### BACKGROUND

The disclosed embodiments of the present invention relate to generating depth information, and more particularly, to a depth information generator for generating a depth information output by only processing part of received images having different views, and related depth information generating method and depth adjusting apparatus thereof.

With the development of science and technology, users are pursing stereo/three-dimensional and more real image displays rather than high quality images. There are two techniques of present stereo image display. One is to use a video output apparatus which collaborates with glasses (e.g., anaglyph glasses, polarization glasses or shutter glasses), while the other is to directly use a video output apparatus without any accompanying glasses. No matter which technique is utilized, the main theory of stereo image display is to make the left eye and the right eye see different images, thus the human brain will regard the different images seen from two eyes as a stereo image.

FIG. 1 is a diagram illustrating how the human depth perception creates a 3D vision. A stereoscopic vision requires two eyes to view a scene with overlapping visual fields. For example, as shown in FIG. 1, each eye views an image point from a slightly different angle, and focuses the image point onto a retina. Next, the two-dimensional (2D) retinal images are combined in the human brain to form a 3D vision. The disparity D of the image point refers to the difference in the image location of an image point seen by the left eye and the right eye, resulting from a particular eye separation, and it is interpreted by the human brain as depth associated with the image point. That is, when the image point is near, the disparity D would be large; however, when the image point is far, the disparity D would be small. More specifically, the disparity D is in inverse proportion to the depth interpreted by the human brain, i.e.,

$$Disparity ∝ \frac{1}{Depth} .$$

When viewing a 3D video content presented by displaying left-eye images and right-eye images included in a stereo video stream, the user may want to adjust the perceived depth to meet his/her viewing preference. Thus, the left-eye images and right-eye images should be properly adjusted to change user's depth perception. A conventional 3D video depth adjustment scheme may be employed to achieve this goal. For example, the conventional 3D video depth adjustment scheme obtains a depth/disparity map by performing a stereo matching operation upon a pair of a left-eye image and a right-eye image, generates an adjusted left-eye image by performing a view synthesis/image rendering operation according to the original left-eye image and the obtained depth/disparity map, and generates an adjusted right-eye image by performing a view synthesis/image rendering operation according to the original right-eye image and the obtained depth/disparity map. Based on the adjusted left-eye image and the adjusted right-eye image, a depth-adjusted 3D video output is therefore presented to the user.

In general, the stereo matching operation needs to simultaneously get the left-eye image and the right-eye image from a memory device such as a dynamic random access memory (DRAM), resulting in significant memory bandwidth consumption. Besides, the stereo matching operation may need to perform pixel-based or block-based matching, which leads to higher hardware cost as well as higher computational complexity. Therefore, there is a need for an innovative design which can obtain the depth information (e.g., a depth map or a disparity map) with less memory bandwidth consumption, lower hardware cost, and/or reduced computational complexity.

### SUMMARY

In accordance with exemplary embodiments of the present invention, a depth information generator for generating a depth information output by only processing part of received images having different views, and related depth information generating method and depth adjusting apparatus thereof are proposed to solve the above-mentioned problems.

According to a first aspect of the present invention, an exemplary depth information generator is disclosed. The exemplary depth information generator includes a receiving circuit and a depth information generating block having a first depth information generating circuit included therein. The receiving circuit is arranged for receiving a multi-view video stream which transmits a plurality of images respectively corresponding to different views. The first depth information generating circuit is coupled to the receiving circuit, and arranged for generating a first depth information output by only processing part of the received images.

According to a second aspect of the present invention, an exemplary depth information generating method is disclosed. The exemplary depth information generating method includes following steps: receiving a multi-view video stream which transmits a plurality of images respectively corresponding to different views; and generating a first depth information output by only processing part of the received images.

According to a third aspect of the present invention, an exemplary depth information generator is disclosed. The exemplary depth information generator includes a receiving circuit, a depth information generating block, and a blending circuit. The receiving circuit is arranged for receiving a multi-view video stream which transmits a plurality of images respectively corresponding to different views. The depth information generating block is coupled to the receiving circuit, and arranged for generating a plurality of depth information outputs by processing the received images. The blending circuit is coupled to the depth information generating block, and arranged for generating a blended depth information output by blending the first depth information output and the second depth information output.

According to a fourth aspect of the present invention, an exemplary depth adjustment apparatus is disclosed. The depth adjustment apparatus includes a depth information generator and a view synthesizing block. The depth information generator includes a receiving circuit and a depth information generating block. The receiving circuit is arranged for receiving a multi-view video stream which transmits a plurality of images respectively corresponding to different views. The depth information generating block includes a first depth information generating circuit, coupled to the receiving circuit and arranged for generating a first depth information output by only processing part of the received images. The view synthesizing block is arranged for generating adjusted images by performing a view synthesis/image rendering operation according to the images and at least one target depth information output derived from at least the first depth information output.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating how the human depth perception creates a three-dimensional vision.

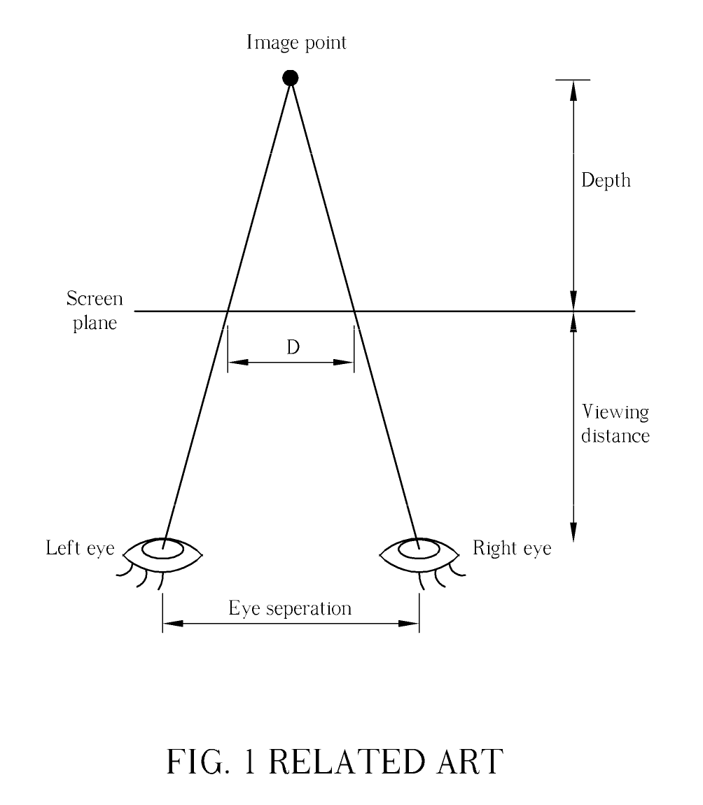

FIG. 2 is a block diagram illustrating a generalized depth adjustment apparatus according to an exemplary embodiment of the present invention.

FIG. 3 is a block diagram illustrating a first exemplary implementation of a depth information generator according to the present invention.

FIG. 4 is a block diagram illustrating a second exemplary implementation of a depth information generator according to the present invention.

FIG. 5 is a block diagram illustrating a third exemplary implementation of a depth information generator according to the present invention.

FIG. 6 is a block diagram illustrating a fourth exemplary implementation of a depth information generator according to the present invention.

FIG. 7 is a block diagram illustrating a fifth exemplary implementation of a depth information generator according to the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

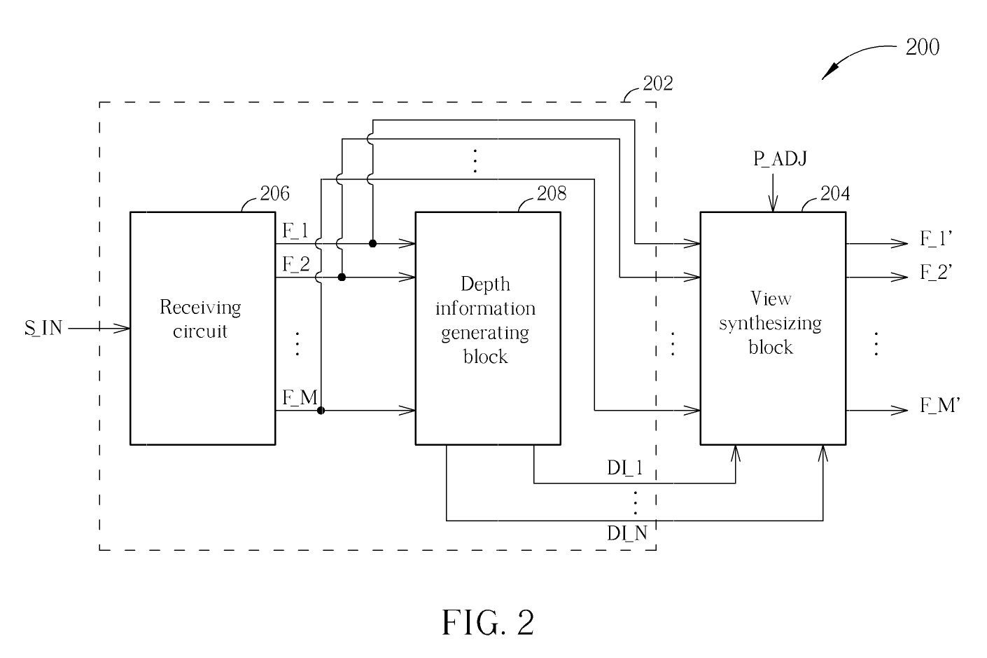

FIG. 2 is a block diagram illustrating a generalized depth adjustment apparatus according to an exemplary embodiment of the present invention. The depth adjustment apparatus 200 includes a depth information generator 202 and a view synthesizing block 204, wherein the depth information generator 202 includes, but is not limited to, a receiving circuit 206 and a depth information generating block 206. The receiving circuit 202 is arranged for receiving a multi-view video stream S_IN such as a stereo video stream. For example, the multi-view video stream S_IN transmits a plurality of images F_1, F_2, . . . , F_M corresponding to different views, respectively. When the multi-view video stream S_IN is a stereo video stream, the number of different views is equal to two, and the images F_1, F_2, . . . , F_M with different views thus include a left-eye image and a right-eye image. By way of example, but not limitation, the receiving circuit 202 may include a buffer device (e.g., a DRAM device) for buffering images transmitted by the multi-view video stream S_IN and transmitting buffered images to a following stage (e.g., the depth information generating block 208) for further image processing.

The depth information generating block 208 is arranged to generate a plurality of depth information outputs DI_1-DI_N to the view synthesizing block 204 according to the received images F_1-F_M. In this exemplary design of the present invention, the depth information generating block 208 does not generate a depth information output by simultaneously referring to all of the received images F_1-F_M with different views. Instead, at least one of the depth information outputs DI_1-DI_N is generated by only processing part of the received images F_1-F_M. For example, one of the depth information outputs DI_1-DI_N is generated by only processing part of the received images F_1-F_M, and another of the depth information outputs DI_1-DI_N is generated by only processing another part of the received images F_1-F_M. In one exemplary implementation, a single-view depth information generation scheme may be employed by the depth information generating block 208 to generate each of the depth information outputs DI_1-DI_N by processing each of the received images F_1-F_M, where the number of the received images F_1-F_M with different views is equal to the number of the depth information outputs DI_1-DI_N. Consider a case where the multi-view video stream S_IN is a stereo video stream carrying left-eye images and right-eye images. As the proposed depth information outputs DI_1-DI_N does not employ the stereo matching technique used in the conventional 3D video depth adjustment design, a depth information generation scheme with less memory bandwidth consumption, lower hardware cost, and/or reduce computational complexity is therefore realized.

The view synthesizing block 204 performs a view synthesis/image rendering operation according to the original images F_1-F_M and the depth information outputs DI_1-DI_N, and accordingly generates adjusted images F_1′-F_M′ for video playback with adjusted depth perceived by the user. As shown in FIG. 2, the view synthesizing block 204 further receives a depth adjustment parameter P_ADJ used to control/tune the adjustment made to the depth perceived by the user. Consider a case where the multi-view video stream SIN is a stereo video stream carrying left-eye images and right-eye images. When viewing the 3D video output presented by displaying the left-eye images and right-eye images, the user may perceive the desired 3D video depth by properly setting the depth adjustment parameter P_ADJ according to his/her viewing preference. Therefore, when an adjusted left-eye image and an adjusted right-eye image generated from the view synthesizing block 204 are displayed, an adjusted 3D video output with the desired 3D video depth is generated. Please note that the view synthesizing block 204 may employ any available view synthesis/image rendering scheme to generate the adjusted images F_1′-F_M′. For example, the view synthesizing block 204 may refer to one depth/disparity map and one image to generate an adjusted image. Alternatively, the view synthesizing block 204 may refer to multiple depth/disparity maps and one image to generate an adjusted image. As the present invention focuses on the depth information generation rather than the view synthesis/image rendering, further description directed to the view synthesizing block 204 is omitted here for brevity.

In the following, several exemplary implementations of the depth information generator 202 shown in FIG. 2 are provided to better illustrate technical features of the present invention. For clarity and simplicity, it is assumed that the aforementioned multi-view video stream S_IN is a stereo video stream which only carries left-eye images and right-eye images arranged in an interleaving manner (i.e., one left-eye image and one right-eye image are alternatively transmitted via the stereo video stream). Therefore, the number of the images F_1-F_M with different views is equal to two, and the images F_1-F_M include a left-eye image F_{L} and a right-eye image F_{R}. However, this is for illustrative purposes only, and is not meant to be a limitation of the present invention.

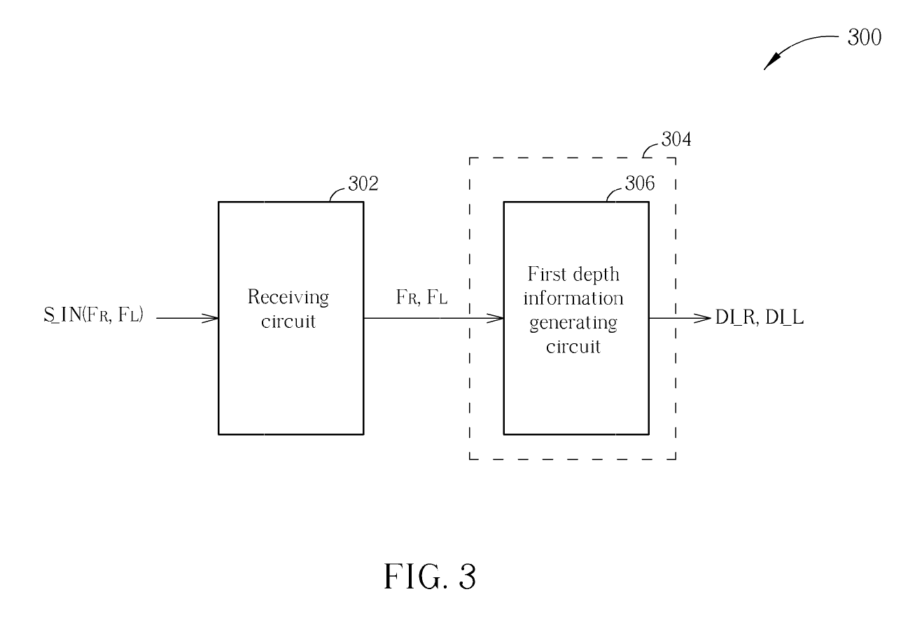

Please refer to FIG. 3, which is a block diagram illustrating a first exemplary implementation of a depth information generator according to the present invention. The depth information generator shown in FIG. 2 may be realized by the exemplary depth information generator 300 shown in FIG. 3. In this exemplary embodiment, the depth information generator 300 includes a receiving circuit 302 and a depth information generating block 304 having a first depth information generating circuit 305 included therein. As shown in FIG. 3, the receiving circuit 300 sequentially receives a left-eye image F_{L} acting as part of the received images with different views and a right-eye image F_{R} acting as another part of the received images with different views, and then sequentially outputs the received left-eye image F_{L} and the received right-eye image F_{R} to the first depth information generating circuit 306. In this exemplary embodiment, the first depth information generating circuit 306 employs a single-view depth information generation scheme which may use an object segmentation technique, a depth cue extraction technique based on contrast/color information, texture/edge information, and/or motion information, or a foreground/background detection technique. Besides, the first depth information generating circuit 306 sequentially generates two depth information outputs DI_L and DI_R in a time sharing manner. That is, after receiving the left-eye image F_{L}, the first depth information generating circuit 306 performs single-view depth information generation upon the single left-eye image F_{L} to therefore generate and output the depth information output DI_L; similarly, after receiving the right-eye image F_{R} immediately following the left-eye image F_{L}, the first depth information generating circuit 306 performs single-view depth information generation upon the single right-eye image F_{R} to therefore generate and output the depth information output DI_R. The depth information outputs DI_L and DI_R are provided to the following view synthesizing block 204 shown in FIG. 2. Next, the view synthesizing block 204 may generate an adjusted left-eye image (e.g., one of the adjusted images F_1′-F_M′) according to the depth information output DI_L and the left-eye image F_{L}, and generate an adjusted right-eye image (e.g., another of the adjusted images F_1′-F_M′) according to the depth information output DI_R and the right-eye image F_{R}.

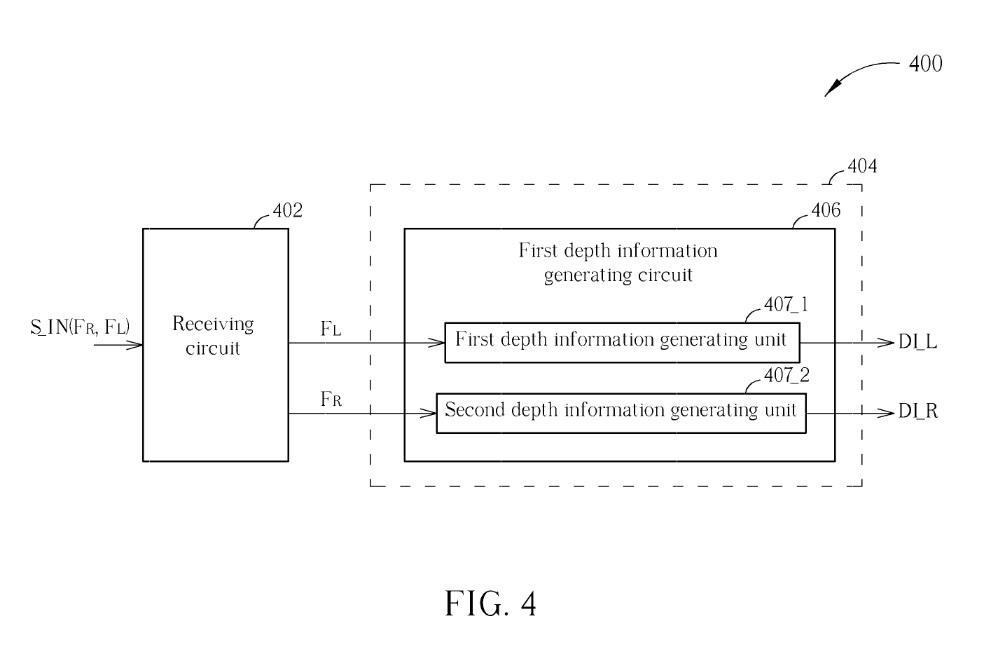

Please refer to FIG. 4, which is a block diagram illustrating a second exemplary implementation of a depth information generator according to the present invention. The depth information generator shown in FIG. 2 may be realized by the exemplary depth information generator 400 shown in FIG. 4. In this exemplary embodiment, the depth information generator 400 includes a receiving circuit 402 and a depth information generating block 404, wherein the depth information generating block 404 includes a first depth information generating circuit 305 having a first depth information generating unit 407_1 and a second depth information generating unit 407_2 included therein. As shown in FIG. 4, the receiving circuit 402 sequentially receives a left-eye image F_{L} acting as part of the received images with different views and a right-eye image F_{R} acting as another part of the received images with different views. Next, the receiving circuit 402 outputs the left-eye image F_{L} and a right-eye image F_{R} to the first depth information generating unit 407_1 and the second depth information generating unit 407_2, respectively. In this exemplary embodiment, each of the first depth information generating unit 407_1 and the second depth information generating unit 407_2 employs a single-view depth information generation scheme which may use an object segmentation technique, a depth cue extraction technique based on contrast/color information, texture/edge information, and/or motion information, or a foreground/background detection technique. After receiving the left-eye image F_{L}, the first depth information generating unit 407_1 performs single-view depth information generation upon the single left-eye image F_{L} to therefore generate and output the depth information output DI_L. Similarly, after receiving the right-eye image F_{R}, the second depth information generating unit 407_2 performs single-view depth information generation upon the single right-eye image F_{R} to therefore generate and output the depth information output DI_R. By way of example, but not limitation, the receiving circuit 402 may transmit the received left-eye image F_{L} to the first depth information generating unit 407_1 and the received right-eye image F_{R} to the second depth information generating unit 407_2, simultaneously. Therefore, the first depth information generating circuit 406 is allowed to process the left-eye image F_{L} and right-eye image F_{R} in a parallel processing manner. The depth information outputs DI_L and DI_R are provided to the following view synthesizing block 204 shown in FIG. 2. Next, the view synthesizing block 204 may generate an adjusted left-eye image (e.g., one of the adjusted images F_1′-F_M′) according to the depth information output DI_L and the left-eye image F_{L}, and generate an adjusted right-eye image (e.g., another of the adjusted images F_1′-F_M′) according to the depth information output DI_R and the right-eye image F_{R}.

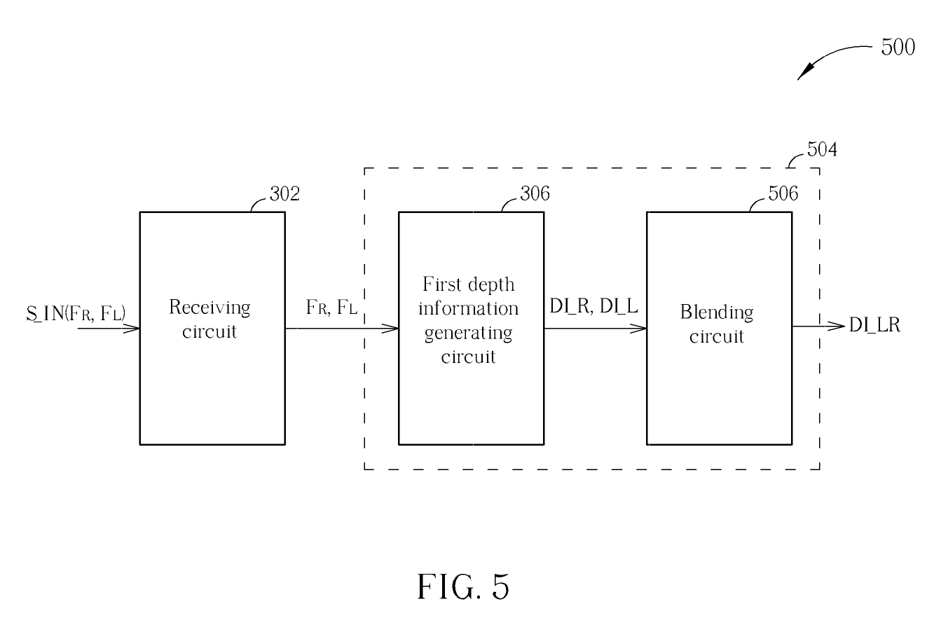

Please refer to FIG. 5, which is a block diagram illustrating a third exemplary implementation of a depth information generator according to the present invention. The depth information generator shown in FIG. 2 may be realized by the exemplary depth information generator 500 shown in FIG. 5. The major difference between the depth information generators 300 and 500 is that the depth information generating block 504 has a blending circuit 506 included therein. After the depth information outputs DI_L and DI_R are sequentially generated from the first depth information generating circuit 306, the blending circuit 506 generates a blended depth information output DI_LR by blending the depth information outputs DI_L and DI_R. For example, the blended depth information output DI_LR may simply be an average of the depth information outputs DI_L and DI_R. However, this is for illustrative purposes only. In an alternative design, a different blending result derived from blending the depth information outputs DI_L and DI_R may be used to serve as the blended depth information output DI_LR. The blended depth information output DI_LR is provided to the following view synthesizing block 204 shown in FIG. 2. Next, the view synthesizing block 204 may generate an adjusted left-eye image (e.g., one of the adjusted images F_1′-F_M′) according to the blended depth information output DI_LR and the left-eye image F_{L}, and generate an adjusted right-eye image (e.g., another of the adjusted images F_1′-F_M′) according to the same blended depth information output DI_LR and the right-eye image F_{R}.

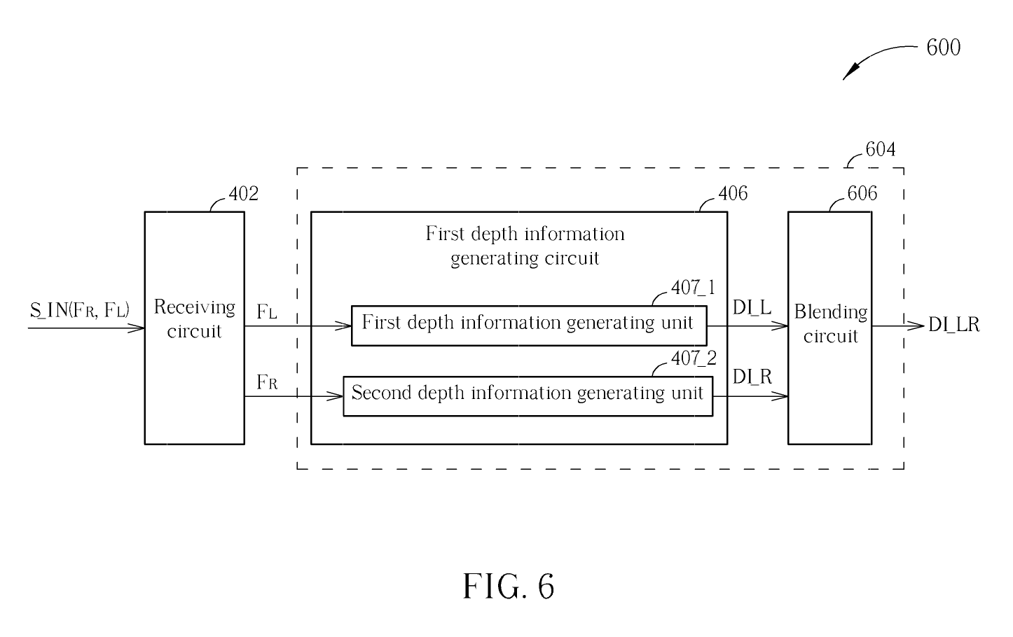

Please refer to FIG. 6, which is a block diagram illustrating a fourth exemplary implementation of a depth information generator according to the present invention. The depth information generator shown in FIG. 2 may be realized by the exemplary depth information generator 600 shown in FIG. 6. The major difference between the depth information generators 400 and 600 is that the depth information generating block 604 has a blending circuit 606 included therein. After the depth information outputs DI_L and DI_R are respectively generated from the first depth information generating unit 407_1 and the second depth information generating unit 407_2, the blending circuit 606 generates a blended depth information output DI_LR by blending the depth information outputs DI_L and DI_R. For example, the blended depth information output DI_LR may simply be an average of the depth information outputs DI_L and DI_R. However, this is for illustrative purposes only. In an alternative design, a different blending result derived from blending the depth information outputs DI_L and DI_R may be used to serve as the blended depth information output DI_LR. The blended depth information output DI_LR is provided to the following view synthesizing block 204 shown in FIG. 2. Next, the view synthesizing block 204 may generate an adjusted left-eye image (e.g., one of the adjusted images F_1′-F_M′) according to the blended depth information output DI_LR and the left-eye image F_{L}, and generate an adjusted right-eye image (e.g., another of the adjusted images F_1′-F_M′) according to the same blended depth information output DI_LR and the right-eye image F_{R}.

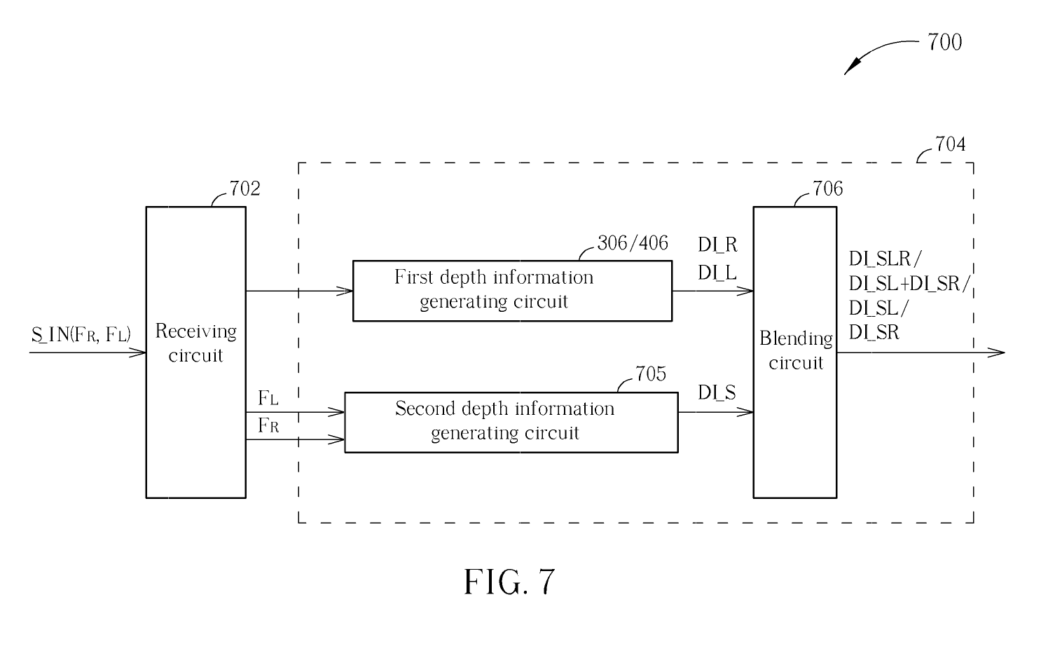

Please refer to FIG. 7, which is a block diagram illustrating a fifth exemplary implementation of a depth information generator according to the present invention. The depth information generator shown in FIG. 2 may be realized by the exemplary depth information generator 700 shown in FIG. 7. The depth information generator 700 includes a receiving circuit 702 and a depth information generating block 704, wherein the depth information generating block 704 includes the aforementioned first depth information generating circuit 306/406, a second depth information generating circuit 705, and a blending circuit 706. In addition to providing the received left-eye image F_{L} and right-eye image F_{R} to the first depth information generating circuit 306/406, the receiving circuit 702 transmits the received left-eye image F_{L} and right-eye image F_{R} to the second depth information generating circuit 705, simultaneously. In this exemplary embodiment, the second depth information generating circuit 705 is arranged to generate a depth information output DI_S by processing all of the received images with different views (i.e., the left-eye image F_{L} and right-eye image F_{R}). For example, the second depth information generating circuit 705 employs the conventional stereo matching technique to generate the depth information output DI_S.

Regarding the blending circuit 706, it is implemented for generating one or more blended depth information outputs according to depth information outputs generated from the preceding first depth information generating circuit 306/406 and second depth information generating circuit 705. In a first exemplary design, the blending circuit 706 may generate a single blended depth information output DI_SLR by blending the depth information outputs DI_L, DI_R, and DI_S. In a second exemplary design, the blending circuit 706 may generate one blended depth information output DI_SL by blending the depth information outputs DI_L and DI_S and the other blended depth information output DI_SR by blending the depth information outputs DI_R and DI_S. In a third exemplary design, the blending circuit 706 may generate a single blended depth information output DI_SL by blending the depth information outputs DI_L and DI_S. In a fourth exemplary design, the blending circuit 706 may generate a single blended depth information output DI_SR by blending the depth information outputs DI_R and DI_S.

The blended depth information output(s) would be provided to the following view synthesizing block 204 shown in FIG. 2. Next, the view synthesizing block 204 may generate an adjusted left-eye image (e.g., one of the adjusted images F_1′-F_M′) and an adjusted right-eye image (e.g., another of the adjusted images F_1′-F_M′) according to the blended depth information output(s), the left-eye image F_{L}, and the right-eye image F_{R}.

In the exemplary embodiments shown in FIGS. 3-7, the first depth information generating circuit 306/406 is capable for performing single-view depth map generation upon a single image to generate a depth information output. Thus, the exemplary depth information generator of the present invention may also be employed in the 2D-to-3D conversion when the video input is a single-view video stream (i.e., a 2D video stream) rather than a multi-view video stream. That is, a 2D image and the depth information output generated from the first depth information generating circuit 306/406 by processing the 2D image may be fed into the following view synthesizing block 204, and then the view synthesizing block 204 may generate a left-eye image and a right-eye image corresponding to the 2D image. Therefore, a cost-efficient design may be realized by using a hardware sharing technique to make the proposed depth information generator shared between a 3D video depth adjustment circuit and a 2D-to-3D conversion circuit.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A depth information generator, comprising:
a receiving circuit, arranged for receiving a multi-view video stream which transmits a plurality of images respectively corresponding to different views; and
a depth information generating block, comprising:
a first depth information generating circuit, coupled to the receiving circuit and arranged for generating a first depth information output by only processing part of the received images.

2. The depth information generator of claim 1, wherein the part of the received images includes a single image of a single view only.

3. The depth information generator of claim 1, wherein the first depth information generating circuit is further arranged for generating a second depth information output by only processing another part of the received images.

4. The depth information generator of claim 3, wherein the part of the received images includes a first image of a first view only, and the another part of the received images includes a second image of a second view only.

5. The depth information generator of claim 3, wherein the receiving circuit receives the images sequentially, and outputs the part of the received images and the another part of the received images to the first depth information generating circuit sequentially; and the first depth information generating circuit sequentially generates the first depth information output and the second depth information output in a time sharing manner.

6. The depth information generator of claim 3, wherein the first depth information generating circuit comprises:
a first depth information generating unit, arranged for receiving the part of the received images from the receiving circuit and generating the first depth information output according to the part of the received images; and
a second depth information generating unit, arranged for receiving the another part of the received images from the receiving circuit and generating the second depth information output according to the another part of the received images.

7. The depth information generator of claim 3, wherein the depth information generating block further comprises:
a blending circuit, coupled to the first depth information generating circuit and arranged for generating a blended depth information output by blending at least the first depth information output and the second depth information output.

8. The depth information generator of claim 3, wherein the depth information generating block further comprises:
a second depth information generating circuit, coupled to the receiving circuit and arranged for generating a second depth information output by processing all of the received images; and
a blending circuit, coupled to the first depth information generating circuit and the second depth information generating circuit, the blending circuit arranged for generating a blended depth information output by blending at least the first depth information output and the second depth information output.

9. The depth information generator of claim 1, wherein the multi-view video stream is a stereo video stream, and the images include a left-eye image and a right-eye image.

10. A depth information generating method, comprising:
receiving a multi-view video stream which transmits a plurality of images respectively corresponding to different views; and
generating a first depth information output by only processing part of the received images.

11. The depth information method of claim 10, wherein the part of the received images includes a single image of a single view only.

12. The depth information method of claim 10, further comprising:
generating a second depth information output by only processing another part of the received images.

13. The depth information method of claim 12, wherein the part of the received images includes a first image of a first view only, and the another part of the received images includes a second image of a second view only.

14. The depth information method of claim 12, wherein the step of receiving the multi-view video stream comprises:
receiving the images sequentially; and
outputting the part of the received images and the another part of the received images sequentially;
wherein the first depth information output and the second depth information output are generated sequentially.

15. The depth information method of claim 12, wherein the step of generating the first depth information output comprises:
utilizing a first depth information generating unit to receive the part of the received images from the receiving circuit and generate the first depth information output according to the part of the received images; and
the step of generating the second depth information output comprises:
utilizing a second depth information generating unit to receive the another part of the received images from the receiving circuit and generate the second depth information output according to the another part of the received images.

16. The depth information method of claim 12, further comprising:
generating a blended depth information output by blending at least the first depth information output and the second depth information output.

17. The depth information method of claim 12, further comprising:
generating a second depth information output by processing all of the received images; and
generating a blended depth information output by blending at least the first depth information output and the second depth information output.

18. The depth information method of claim 10, wherein the multi-view video stream is a stereo video stream, and the images include a left-eye image and a right-eye image.

19. A depth information generator, comprising:
a receiving circuit, arranged for receiving a multi-view video stream which transmits a plurality of images respectively corresponding to different views;
a depth information generating block, coupled to the receiving circuit and arranged for generating a plurality of depth information outputs by processing the received images; and
a blending circuit, coupled to the depth information generating block and arranged for generating a blended depth information output by blending at least the first depth information output and the second depth information output.

20. The depth information generator of claim 19, wherein the multi-view video stream is a stereo video stream, and the images include a left-eye image and a right-eye image.

21. A depth adjustment apparatus, comprising:
a depth information generator, comprising:
a receiving circuit, arranged for receiving a multi-view video stream which transmits a plurality of images respectively corresponding to different views; and
a depth information generating block, comprising:
a first depth information generating circuit, coupled to the receiving circuit and arranged for generating a first depth information output by only processing part of the received images; and
a view synthesizing block, arranged for generating adjusted images by performing a view synthesis/image rendering operation according to the images and at least one target depth information output derived from at least the first depth information output.

22. The depth adjustment apparatus of claim 21, wherein the part of the received images includes a single image of a single view only.

23. The depth adjustment apparatus of claim 21, wherein the first depth information generating circuit is further arranged for generating a second depth information output by only processing another part of the received images; and the at least one target depth information output is derived from at least the first depth information output and the second depth information output.

24. The depth adjustment apparatus of claim 23, wherein the part of the received images includes a first image of a first view only, and the another part of the received images includes a second image of a second view only.

25. The depth adjustment apparatus of claim 23, wherein the receiving circuit receives the images sequentially, and outputs the part of the received images and the another part of the received images to the first depth information generating circuit sequentially; and the first depth information generating circuit sequentially generates the first depth information output and the second depth information output in a time sharing manner.

26. The depth adjustment apparatus of claim 23, wherein the first depth information generating circuit comprises:
a first depth information generating unit, arranged for receiving the part of the received images from the receiving circuit and generating the first depth information output according to the part of the received images; and
a second depth information generating unit, arranged for receiving the another part of the received images from the receiving circuit and generating the second depth information output according to the another part of the received images.

27. The depth adjustment apparatus of claim 23, wherein the depth information generating block further comprises:
a blending circuit, coupled to the first depth information generating circuit and arranged for generating a blended depth information output by blending at least the first depth information output and the second depth information output, wherein the at least one target depth information output is derived from the blended depth information output.

28. The depth adjustment apparatus of claim 23, wherein the depth information generating block further comprises:
a second depth information generating circuit, coupled to the receiving circuit and arranged for generating a second depth information output by processing all of the received images; and
a blending circuit, coupled to the first depth information generating circuit and the second depth information generating circuit, the blending circuit arranged for generating a blended depth information output by blending at least the first depth information output and the second depth information output, wherein the at least one target depth information output is derived from the blended depth information output.

29. The depth adjustment apparatus of claim 21, wherein the multi-view video stream is a stereo video stream, the images include a left-eye image and a right-eye image, and the adjusted images include an adjusted left-eye image and an adjusted right-eye image.
